(19) United States
(12) Patent Application Publication
(10) Pub. No.: US 2026/0296584 A1
(43) Pub. Date: Oct. 1, 2026

(54) METHOD FOR MANUFACTURING A DOOR HOLE COVER MOUNTING STRUCTURE

(71) Applicants: NIFCO INC., Yokosuka-shi (JP); HONDA MOTOR CO., LTD., Tokyo (JP)

(72) Inventors: Yohei WAKATSUKI, Kanagawa (JP); Masakazu ENDO, Kanagawa (JP); Yoshihiro MAENO, Tokyo (JP)

(21) Appl. No.: 19/553,821

(22) Filed: Mar. 2, 2026

(30) Foreign Application Priority Data
Mar. 31, 2025 (JP) 2025-058399

(51) Int. Cl. B62D 65/14; B60R 13/02; B60R 16/02

(52) U.S. Cl. CPC B62D 65/14; B60R 13/0243; B60R 16/0215

(57) ABSTRACT

A door hole cover mounting structure is provided with a door hole extending through an inner panel and a door hole cover including a cover body, a cover peripheral portion, an insert hole into which a cable can be inserted, a passage connecting the insert hole to an outer edge of the cover peripheral portion, and a pivotable piece pivotally mounted on the cover peripheral portion, which is pivotable to open and close the passage. A method for manufacturing a door hole cover mounting structure comprises opening the pivotable piece and placing the cable through the passage into the insert hole; applying a sealant to the edge of the door hole; bringing the cover peripheral portion and the pivotable piece into contact with the edge of the door hole via the sealant; and connecting the cover peripheral portion to the inner panel.

### TECHNICAL FIELD

The present invention relates to a method for manufacturing a door hole cover mounting structure.

### BACKGROUND ART

Known technical ideas include providing a door hole in an inner panel of a vehicle door for cable routing. In this case, a door hole cover is provided over the door hole in order to prevent rainwater and other substances from entering the vehicle interior. Patent Document 1 discloses a door hole cover comprising a cover member with a through hole for cable insertion, a sealing member on an outer periphery of the cover member, and a cover body with an insertion hole for cable insertion that covers the through hole from the exterior side of a vehicle.

Patent Document 2 discloses a door hole cover which is a tubular plug insertable into a door hole. The door hole cover is provided with a harness hole for insertion of a harness and a flexible tongue for opening and closing the harness hole at the center thereof.

### PRIOR ART DOCUMENTS

### PATENT DOCUMENTS

Patent Document 1: JP2024-008659A

Patent Document 2: JPH09-309391A

### SUMMARY OF THE INVENTION

### TASK TO BE ACCOMPLISHED BY THE INVENTION

However, in the case of both Patent Documents 1 and 2, assembling a cable into the door hole cover requires passing one end of the cable through the door hole cover first. This means that, when both ends of the cable are connected to other devices, the cable cannot be assembled into the door hole cover. Thus, door hole covers of the prior art have a problem that the work of assembling the cable into the door hole cover is made inefficient.

The present invention has been made in view of the problem of the prior art, and a primary object of the present invention is to provide a method for manufacturing a door hole cover mounting structure, which improves the efficiency of the work of assembling a cable into a door hole cover.

### MEANS TO ACCOMPLISH THE TASK

As a solution to the above-described task to be accomplished, an aspect of the present invention provides a method for manufacturing a door hole cover mounting structure (18) comprising a door hole (20) extending through an inner panel (4) of a vehicle door (1) and a door hole cover (22) for closing the door hole, wherein the door hole cover comprises: a cover body (27) facing the door hole; a cover peripheral portion (28) extending along an outer periphery of the cover body, the cover peripheral portion overlapping an edge of the door hole when viewed along an axis of the door hole; an insert hole (33) extending through the cover peripheral portion to connect to the door hole, wherein a cable (21) can be inserted into the insert hole; a passage (34) connecting the insert hole to an outer edge (28A) of the cover peripheral portion; and a pivotable piece (40) pivotally mounted on the cover peripheral portion, which is pivotable to open and close the passage, the method comprising: opening the pivotable piece and placing the cable through the passage into the insert hole; applying a sealant (55) to the edge of the door hole; bringing the cover peripheral portion and the pivotable piece into contact with the edge of the door hole via the sealant; and connecting the cover peripheral portion to the inner panel.

This configuration can provide a method for manufacturing a door hole cover mounting structure, which improves the efficiency of the work of assembling a cable into a door hole cover. An assembly worker can operate the pivotable piece to open the passage, thereby placing the cable into the insert hole through the passage. After the cable is placed in the insert hole, the pivotable piece closes the passage, thereby preventing rainwater and other substances from passing through the passage.

The above-described method may be further configured such that the cover peripheral portion includes a first wall (35A) and a second wall (35B) which define the passage, wherein a base end of the pivotable piece is provided with a hinge (41) pivotally connected to the first wall, and wherein a tip end of the pivotable piece is provided with an engaging part (42) that can engage an edge of the second wall on the inner panel side.

This configuration allows the engaging part to be engaged with the edge of the inner panel side of the second wall, which maintains the pivotable piece in a closed state for the passage.

### EFFECT OF THE INVENTION

According to the above-described embodiments of the present invention, it is possible to provide a method for manufacturing a door hole cover mounting structure which improves the efficiency of the work of assembling a cable into a door hole cover.

### BRIEF DESCRIPTION OF THE DRAWINGS

FIG. 1 is a cross-sectional view of a door hole cover mounting structure according to an embodiment of the present invention;

FIG. 2 is a perspective view showing the door hole cover mounting structure as viewed from the exterior side of a vehicle;

FIG. 3 is a perspective view showing the door hole cover mounting structure as viewed from the interior of the vehicle;

FIG. 4 is a perspective view of a door hole cover;

FIG. 5 is a perspective view showing an enlarged detail of the door hole cover;

FIG. 6 is a cross-sectional view of a pivotable piece of the door hole cover;

FIG. 7 is a plan view showing the door hole cover as vied from a first surface side;

FIG. 8 is a perspective view of the door hole cover with the pivotable piece in its open position; and

FIG. 9 is a perspective view showing the door hole cover with the pivotable piece in its open position and a cable attached thereto.

### DESCRIPTION OF THE PREFERRED EMBODIMENTS

Embodiments of a method for manufacturing a door hole cover mounting structure will be described with reference to the appended drawings.

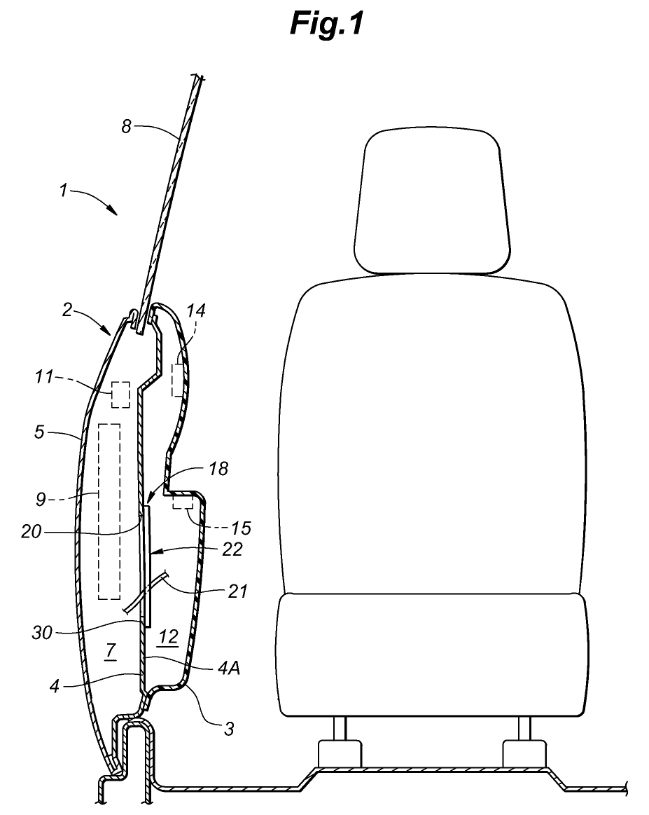

As shown in FIG. 1, a vehicle door 1 includes a door panel 2 provided as a door frame member, and a door trim 3 that covers an interior side surface of the door panel 2.

The door panel 2 has an inner panel 4 and an outer panel 5 both formed of a steel plate. The inner panel 4 is positioned on the interior side of the outer panel 5, which forms an exterior surface of a vehicle body. The inner panel 4 and outer panel 5 are connected to each other along their front edges, lower edges, and rear edges, with no connection along their upper edges. A first space 7 is formed between the inner panel 4 and the outer panel 5.

Provided within the first space 7 are a window glass 8 and a lifting and lowering device 9 for lifting and lowering the window glass 8. The window glass 8 moves vertically through an opening formed between the upper edge of the inner panel 4 and the upper edge of the outer panel 5. A weather-strip, which is a sealing member that slidingly contacts the window glass 8, is provided on each of the upper edges of the inner panel 4 and the outer panel 5. A door latch device 11, which detachably engages a striker provided on the vehicle body, is provided at the rear end of the first space 7.

The door trim 3 is formed of a plastic material. The door trim 3 is positioned on the passenger compartment side of the inner panel 4. A second space 12 is formed between the door trim 3 and the inner panel 4. The inner panel 4 is equipped with a door handle 14 for operating the door latch device 11, a window switch 15 for operating the lifting and lowering device 9, and other devices such as speakers.

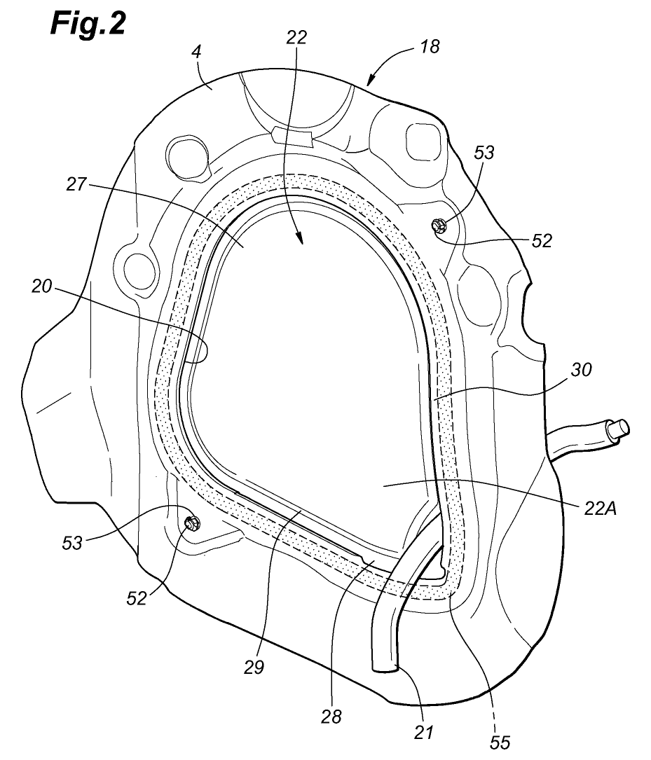

As shown in FIGS. 1 and 2, a door hole 20 is defined in the inner panel 4. The door hole 20 extends through the inner panel 4 in its thickness direction. The door hole 20 connects the first space 7 to the second space 12. A cable 21 for connecting various devices extends from first space 7 to second space 12 through the door hole 20. The cable 21 may be, for example, a control cable connecting a door handle 14 and the door latch device 11, or a wire harness connecting the window switch 15 and the lifting and lowering device 9.

As shown in FIGS. 1 to 3, the door hole 20 is closed by a door hole cover 22. As used herein, a door hole cover mounting structure 18 is a structure in which the door hole cover 22 is mounted on the inner panel 4 and the door hole 20 is closed by the door hole cover 22.

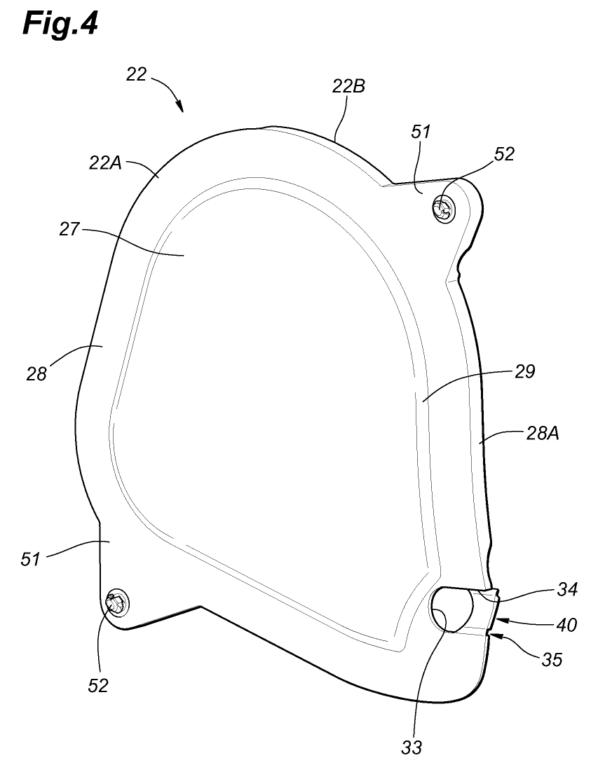

As shown in FIG. 4, the door hole cover 22 is formed in a plate-like shape and has a first surface 22A facing toward the side of the inner panel 4 and a second surface 22B opposite the first surface 22A. The door hole cover 22 has a cover body 27 and a cover peripheral portion 28 provided along an outer periphery of the cover body 27. The cover peripheral portion 28 may be formed annularly along the outer periphery of the cover body 27. On the first surface 22A, the cover body 27 protrudes toward the side of the inner panel 4 relative to the cover peripheral portion 28, and a step 29 is formed at the boundary between the cover body 27 and the cover peripheral portion 28. The step 29 increases the rigidity of the door hole cover 22. The step 29 may be formed into a shape that can be fitted into the door hole 20.

The door hole cover 22 covers the door hole 20 from the interior side of the inner panel 4. The cover body 27 faces the door hole 20. The cover peripheral portion 28 overlaps with the edge 30 of the door hole 20 as viewed along the direction of an axis of the door hole 20. That is, the cover peripheral portion 28 partially faces the edge 30 of the door hole 20 and contacts the edge 30 via a sealant 55 as described later. Specifically, a part of the cover peripheral portion 28 faces an interior surface 4A of the inner panel 4, which forms the edge 30 of the door hole 20, in the thickness direction of the cover body 27. As viewed in the thickness direction of the cover body 27, the door hole 20 is positioned inside an outer edge 28A of the cover peripheral portion 28. That is, as viewed along the thickness direction of the cover body 27, the entire door hole 20 overlaps with the door hole cover 22.

The door hole cover 22 has an insert hole 33 and a passage 34 connected to the insert hole 33. The insert hole 33 extends through the cover peripheral portion 28 to connect to the door hole 20 and is configured to receive the cable 21. The passage 34 connects the insert hole 33 to the outer edge 28A of the cover peripheral portion 28. Specifically, the passage 34 extends from the insert hole 33, passes through the cover peripheral portion 28, and opens at the outer edge 28A of the cover peripheral portion 28. That is, the passage 34 extends from the insert hole 33 to the outer edge 28A of the cover peripheral portion 28. The passage 34 extends through the cover peripheral portion 28 in the thickness direction thereof. The insert hole 33 and passage 34 cooperatively form a recess 35. The recess 35 is recessed from the outer edge 28A of the cover peripheral portion 28 toward the central portion of the door hole cover 22, and extends through the door hole cover 22 in the thickness direction.

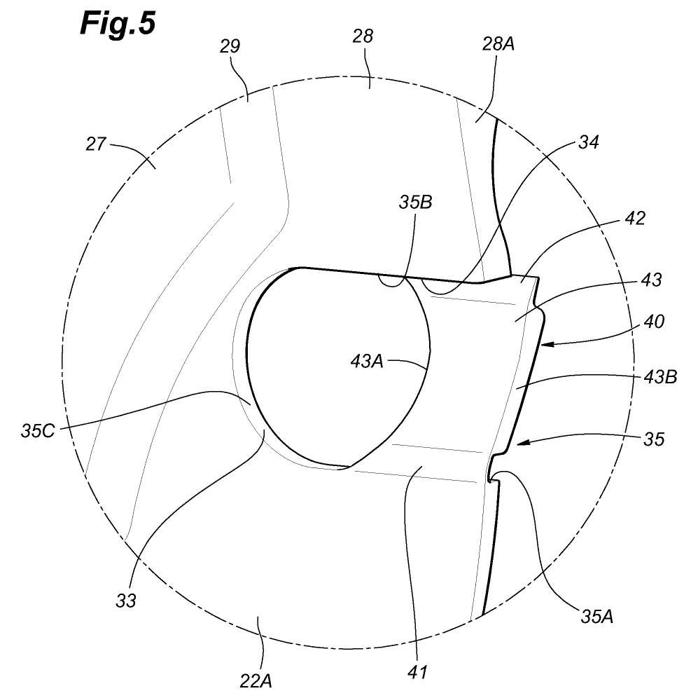

As shown in FIG. 5, the cover peripheral portion 28 has a first wall 35A and a second wall 35B which define the passage 34. The first wall 35A and the second wall 35B face each other and are spaced apart at a distance. The first wall 35A and the second wall 35B extend parallel to each other. One end of each of the first wall 35A and the second wall 35B is connected to the outer edge 28A of the cover peripheral portion 28, while the other end of a corresponding one of the first wall 35A and the second wall 35B is connected to a third wall 35C. The third wall 35C is formed as an arc-shaped curved surface. The other ends of the first wall 35A and the second wall 35B, together with the third wall 35C, define the insert hole 33.

The first wall 35A and the second wall 35B are formed such that the distance therebetween is greater than a diameter of the cable 21 so that the cable 21 can pass through the passage 34. Preferably, the distance between the first wall 35A and the second wall 35B is relatively close to the diameter of the cable 21 so that the gap between the cable 21 and the first wall 35A and the second wall 35B becomes small. The third wall 35C is formed such that the diameter thereof is greater than the diameter of the cable 21 to form an insertion hole through which the cable 21 can pass. Preferably, the diameter of the third wall 35C is relatively close to the diameter of the cable 21 so that the gap between the cable 21 and the third wall 35C becomes small.

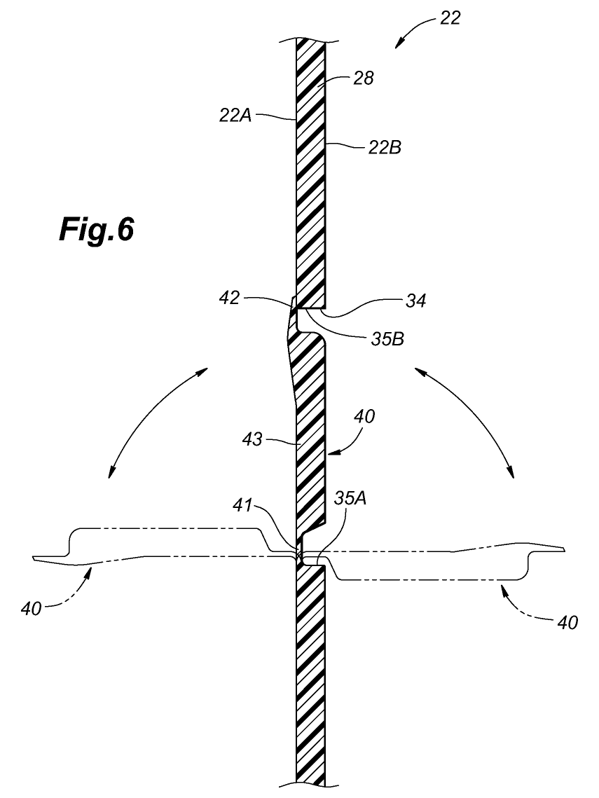

As shown in FIGS. 5 and 6, the cover peripheral portion 28 is provided with a pivotable piece 40 that opens and closes the passage 34. The pivotable piece 40 is pivotally provided on the cover peripheral portion 28 and can pivot to open and close the passage 34. A base end of the pivotable piece 40 has a hinge 41 pivotally connected to the first wall 35A. The pivotable piece 40 has a tip end provided with an engaging part 42 that engages with an edge of the second wall 35B on the side of the inner panel 4. The pivotable piece 40 has a plate-shaped body 43 to which the hinge 41 and the engaging part 42 are connected.

The plate-shaped body 43 has a plate thickness that is smaller than that of the cover peripheral portion 28. The hinge 41 may be an integral hinge formed integrally with the plate-shaped body 43 and the cover peripheral portion 28. The hinge 41 has a thinner plate thickness relative to the plate-shaped body 43 and is made flexible. The hinge 41 is positioned at the edge of the first wall 35A on the side of the first surface 22A. The hinge 41 has a rotation axis, which may extend parallel to an intersection line of the first surface 22A and the first wall 35A.

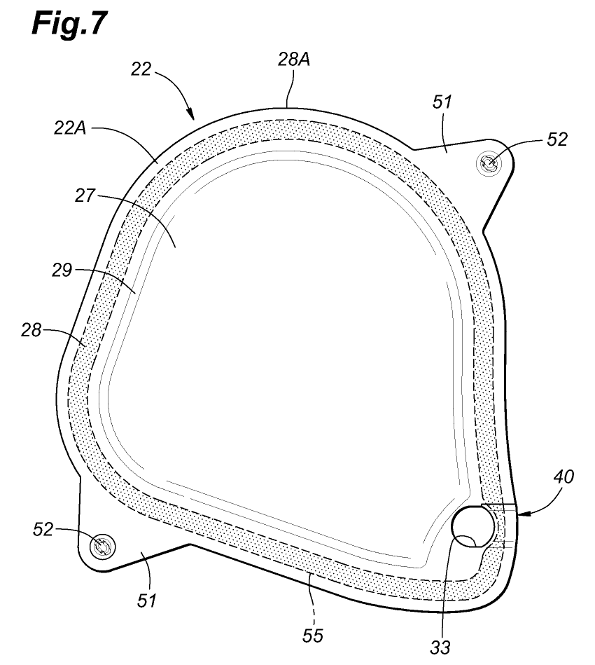

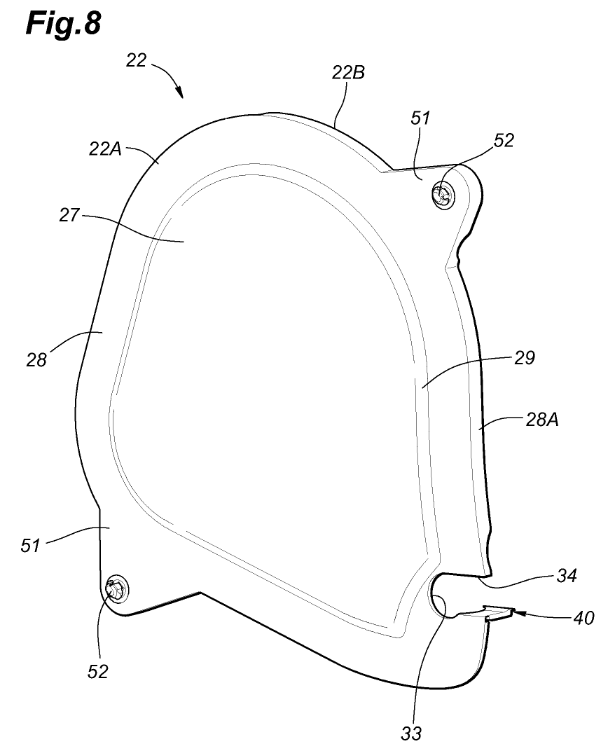

The pivotable piece 40 pivots or rotates about the hinge 41 so that the plate-shaped body 43 thereof is positioned in a closed position and an open position. As shown in FIGS. 6 and 7, when the pivotable piece 40 is in the closed position, the plate-shaped body 43 of the pivotable piece 40 extends from the first wall 35A to the second wall 35B along the first surface 22A. When the pivotable piece 40 is in the closed position, the passage 34 is closed by the pivotable piece 40, which prevents the cable 21 from passing the passage 34. As shown in FIG. 8, when the pivotable piece 40 is in the open position, the plate-shaped body 43 of the pivotable piece 40 extends parallel to the first wall 35A. When the pivotable piece 40 is in the open position, the plate-shaped body 43 may face the first wall 35A and may protrude outward from the first surface 22A. The hinge 41 may provide a restoring force to urge the pivotable piece 40 toward the closed position.

As shown in FIG. 6, the engaging part 42 may be a thin plate protruding parallel to the plate-shaped body 43 from the tip of the plate-shaped body 43. The engaging part 42 has higher flexibility than the plate-shaped body 43. The engaging part 42 may be positioned in the same plane as the surface of the plate-shaped body 43 on the side of the first surface 22A. When the pivotable piece 40 is in the closed position, the engaging part 42 extends beyond the end of the second wall 35B to contact the first surface 22A. The contact between the engaging part 42 and the first surface 22A restricts movement of the pivotable piece 40 toward the side of the first wall 35A.

As shown in FIG. 5, the plate-shaped body 43 has an inner periphery 43A and an outer periphery 43B. The inner periphery 43A defines the insert hole 33 in cooperation with the first wall 35A, the second wall 35B, and the third wall 35C. The inner periphery 43A is preferably formed as an arc-shaped curved surface to minimize the gap with the outer surface of the cable 21. The outer periphery 43B extends along a virtual line extrapolated from the outer edge 28A of the cover peripheral portion 28.

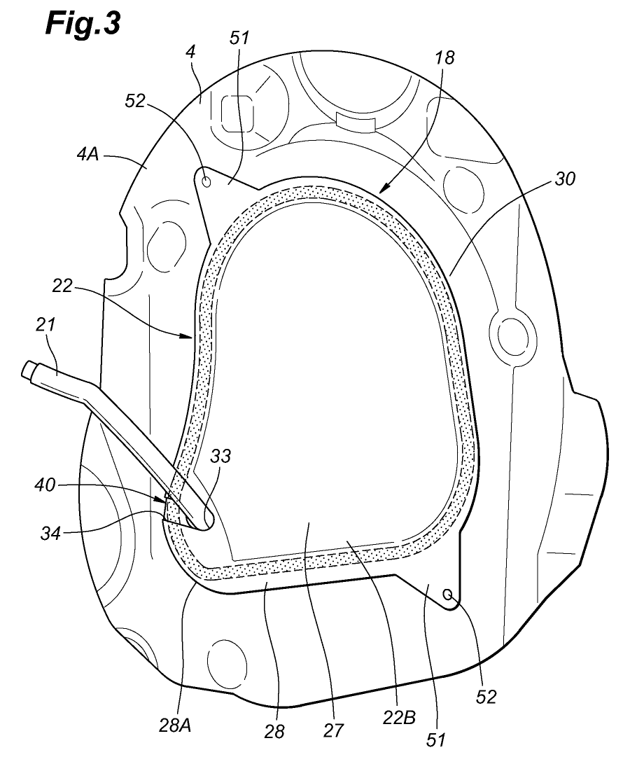

As shown in FIG. 3, the cover peripheral portion 28 has a plurality of fastening portions 51. Each fastening portion 51 is formed in a plate-like shape and extends away from the cover body 27. Each of the plurality of fastening portions 51 contacts the interior surface 4A of the inner panel 4 and is fastened to the inner panel 4. The plurality of fastening portions 51 are fastened to the inner panel 4 by corresponding fastening members 52. Each of the fastening members 52 may be a clip fitted to a corresponding one of the fastening portions 51. The fastening members 52 protrude toward the side of the inner panel 4 from the corresponding fastening portions 51. As shown in FIG. 2, the plurality of fastening members 52 may be coupled to corresponding coupling holes 53 formed in the inner panel 4.

A method for manufacturing the door hole cover mounting structure 18 will be described below. The method for manufacturing the door hole cover mounting structure 18 comprises the steps of opening the pivotable piece 40 and placing the cable 21 through the passage 34 into the insert hole 33; applying the sealant 55 to the edge 30 of the door hole 20; bringing the cover peripheral portion 28 and the pivotable piece 40 into contact with the edge 30 of the door hole 20 via the sealant 55; and connecting the cover peripheral portion 28 to the inner panel 4.

An example of the method for manufacturing the door hole cover mounting structure 18 (i.e., method for attaching the door hole cover 22 to the inner panel 4) will be described. First, an assembly worker places the cable 21 through the passage 34 into the insert hole 33. In this step, the worker may press the plate-shaped body 43 of the pivotable piece 40 with a side of the cable 21 to pivot the pivotable piece 40 to the open position. This opens the passage 34, allowing the cable 21 to pass through the passage 34. Alternatively, the worker may press the pivotable piece 40 with a finger to pivot the pivotable piece 40 to the open position.

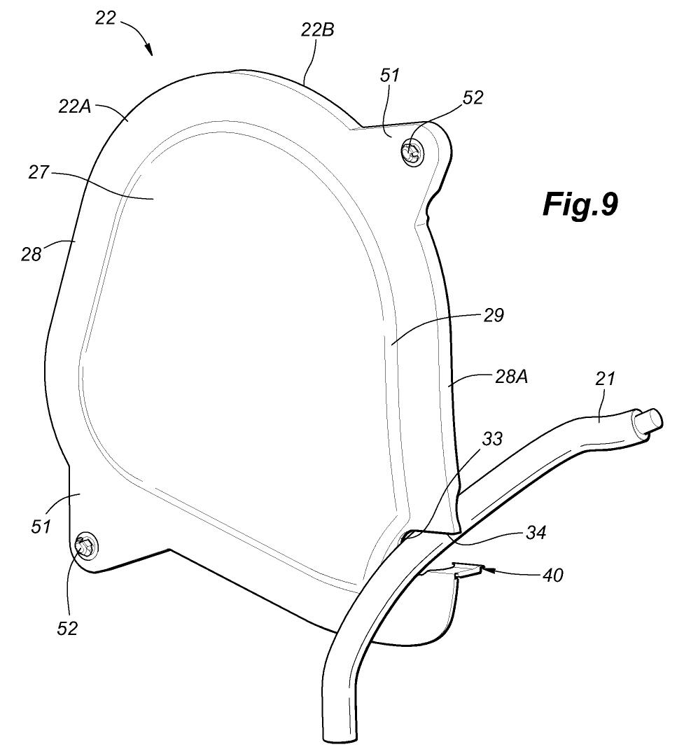

Next, the worker moves the side portion of the cable 21 through the passage 34 into the insert hole 33 while maintaining the pivotable piece 40 in the open position. As a result, the cable 21 is positioned in the insert hole 33, as shown in FIG. 9. Because the cable 21 is positioned in the insert hole 33, a side part of the cable 21 moves away from the plate-shaped body 43 of the pivotable piece 40. As a result, the pivotable piece 40 moves toward the closed position due to its restoring force. A sealing member may be fitted to the portion of the outer peripheral surface of the cable 21 corresponding to the insert hole 33. The cable 21 may be press-fitted into the insert hole 33 together with the sealing member. The sealing member seals the gap between the outer peripheral surface of the cable 21 and the periphery (first wall 35A, second wall 35B, third wall 35C, inner periphery 43A) of the insert hole 33. The sealing member may, for example, be formed from a foam material (sponge) and wound around the outer peripheral surface of the cable 21.

Next, the worker holds the pivotable piece 40 and positions it in the closed position (FIG. 7). In this step, the engaging part 42 deforms to pass through the end of the second wall 35B on the side of the first surface 22A and becomes latched to the end of the second wall 35B on the side of the first surface 22A. That is, the engaging part 42 contacts the first surface 22A. This restricts movement of the pivotable piece 40 toward the side of the first wall 35A (the open position side).

Next, the worker applies the sealant 55 to the edge 30 of the door hole 20 on the interior surface of the inner panel 4. The sealant 55 may be vulcanized rubber or non-vulcanized rubber. The sealant 55 may be, for example, non-vulcanized butyl rubber. The worker applies the sealant 55 so that the sealant encircles the door hole 20 in a ring shape. The step of applying the sealant 55 to the edge 30 of the door hole 20 may be performed before the step of placing the cable 21 into the insert hole 33.

Next, the worker installs the door hole cover 22, with the cable 21 attached thereto, onto the door hole 20. In this step, the cable 21 moves axially within the insert hole 33. As a result, the cover body 27 faces the door hole 20, and the cover peripheral portion 28 and pivotable piece 40 contact the edge 30 of the door hole 20 via the sealant 55. In this step, the cover body 27 may be fitted into the insert hole 33, positioning the door hole cover 22 in place relative to the insert hole 33. Furthermore, a clip fitted to each of the fastening portions 51 engages with a corresponding coupling hole 53 of the inner panel 4. Thus, the door hole cover 22 is mounted on the door hole 20, closing the door hole 20. In this way, the door hole cover mounting structure 18 is formed (FIGS. 2 and 3).

In the door hole cover mounting structure 18, the engaging part 42 of the pivotable piece 40 is clamped between the edge 30 of the door hole 20 and the first surface 22A. This maintains the pivotable piece 40 in the closed position. When the sealant 55 is non-vulcanized butyl rubber, the cover peripheral portion 28 and the pivotable piece 40 are adhered to the edge 30 of the door hole 20 by the sealant 55. The pivotable piece 40 is also maintained in the closed position by the sealant 55.

The passage 34 connects the insert hole 33 to the outer edge 28A of the cover peripheral portion 28, allowing the worker to directly insert a middle part of the cable 21 into the insert hole 33. This improves the efficiency of the work of assembling the cable 21 into the door hole cover 22. The worker can position the cable 21 into the insert hole 33 via the passage 34 by operating the pivotable piece 40 to open the passage 34. After the cable 21 is positioned in the insert hole 33, the pivotable piece 40 closes the passage 34, thereby preventing rainwater and other substances from passing the through passage 34. The pivotable piece 40 is integrally formed with the cover peripheral portion 28, which eliminates the need to assemble the pivotable piece 40 into the passage 34, while preventing the pivotable piece 40 from coming off the passage 34. This further improves the efficiency of the work of assembling the cable 21 into the door hole cover 22.

The present invention has been described in terms of specific embodiments. However, it is not limited by such embodiments, and can be embodied with various modifications. For example, the insert hole 33 may be formed in the cover body 27. In this case, the passage 34 preferably extends across the cover peripheral portion 28 and also is formed in the cover body 27. Furthermore, the pivotable piece 40 preferably extends so as to match the shape of the passage 34.

1. A method for manufacturing a door hole cover mounting structure comprising a door hole extending through an inner panel of a vehicle door and a door hole cover for closing the door hole,
wherein the door hole cover comprises:
a cover body facing the door hole;
a cover peripheral portion extending along an outer periphery of the cover body, the cover peripheral portion overlapping an edge of the door hole when viewed along an axis of the door hole;
an insert hole extending through the cover peripheral portion to connect to the door hole, wherein a cable can be inserted into the insert hole;
a passage connecting the insert hole to an outer edge of the cover peripheral portion; and
a pivotable piece pivotally mounted on the cover peripheral portion, which is pivotable to open and close the passage, and
wherein the method comprises:
opening the pivotable piece and placing the cable through the passage into the insert hole;
applying a sealant to the edge of the door hole;
bringing the cover peripheral portion and the pivotable piece into contact with the edge of the door hole via the sealant; and
connecting the cover peripheral portion to the inner panel.

2. The method as claimed in claim 1, wherein the cover peripheral portion includes a first wall and a second wall which define the passage,
wherein a base end of the pivotable piece is provided with a hinge pivotally connected to the first wall, and
wherein a tip end of the pivotable piece is provided with an engaging part that can engage an edge of the second wall on the inner panel side.
